(19) United States
(12) Patent Application Publication
(10) Pub. No.: US 2009/0048727 A1
(43) Pub. Date: Feb. 19, 2009

(54) Robot cleaner and control method and medium of the same

(75) Inventors: Jun Pyo Hong, Suwon-si (KR); Woo Ram Chung, Hwaseong-si (KR); Jae Man Joo, Suwon-si (KR); Dong Won Kim, Suwon-si (KR); Chang Woo Kim, Seoul (KR); Kyung Hwan Yoo, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/216,802

(22) Filed: Jul. 10, 2008

(30) Foreign Application Priority Data
Aug. 17, 2007 (KR) 10-2007-82725
Mar. 10, 2008 (KR) 10-2008-21869

(51) Int. Cl. G05D 1/02

(52) U.S. Cl. 701/26

(57) ABSTRACT

Disclosed herein are a robot cleaner that is capable of reflecting an obstacle sensed by obstacle sensors on a local map and a control method and medium of the same. The robot cleaner includes an obstacle sensor to sense an obstacle, a memory to store a local map, and a control unit to calculate an obstacle position using the obstacle sensor and to reflect the obstacle position around the robot cleaner on the local map.

### CROSS-REFERENCE TO RELATED APPLICATIONS

This application claims the priority benefit of Korean Patent Application No. 2007-82725 and No. 2008-21869, filed on Aug. 17, 2007 and Mar. 10, 2008 in the Korean Intellectual Property Office, the disclosures of which are incorporated herein by reference.

### BACKGROUND

1. Field

The present invention relates to a robot cleaner, and, more particularly, to a robot cleaner that is capable of reflecting an obstacle sensed by obstacle sensors on a local map and a control method and medium of the same.

2. Description of the Related Art

Generally, a cleaner is an appliance that suctions air, including foreign matter on the floor, using a vacuum pressure of a vacuum pump installed in a cleaner body, filters the foreign matter off in the cleaner body, and discharges the filtered air, i.e., air from which the foreign matter has been removed, out of the cleaner body, to clean the floor.

It is required for a user to move around the floor while holding the cleaner to clean the floor. Consequently, the cleaner is inconvenient to use. In recent years, battery-type robot cleaners constructed to automatically advance in a cleaning zone to perform a cleaning process have been placed on the market.

However, such robot cleaners have problems in that the robot cleaners deviate from an advance path or are damaged due to frequent collision between the robot cleaners and obstacles while the robot cleaners automatically advance along the advance path.

In order to solve the above-mentioned problems, Korean Patent Application Publication No. 2006-0095657 discloses a robot cleaner constructed in a structure in which an infrared sensor or an ultrasonic sensor is installed at the circumference of a cleaner body of the robot cleaner to evade an obstacle.

The infrared sensor may be used to determine whether an obstacle exists in a predetermined distance to reduce the speed of the robot cleaner or stop the robot cleaner in consideration of a possibility of collision with the obstacle. Alternatively, the infrared sensor may be installed at the side of the robot cleaner to allow the robot cleaner to perform wall tracing advance. However, the infrared sensor has a drawback in that the infrared sensor is very sensitive to external lighting. Therefore, the infrared sensor has low reliability in sensing an obstacle.

The ultrasonic sensor may be used to sense whether an obstacle exists in a wide zone and sense the distance to the obstacle. However, the ultrasonic sensor has a drawback in that the ultrasonic sensor cannot sense the position of the obstacle within a sensible zone thereof.

In order to remedy the drawbacks of the infrared sensor and the ultrasonic sensor, it is possible to propose an obstacle distance sensor, e.g. a position sensitive detector, including a light emitter and a light receiver, insensitive to external lighting, to sense the distance between the robot cleaner and the obstacle, whether the obstacle exists or not, and the position of the obstacle using trigonometry.

However, the robot cleaner using the above-described obstacle distance sensor has a problem in that the obstacle distance sensor has a sensible zone narrower than the ultrasonic sensor, whereby it is not possible to sense the distance between the robot cleaner and the obstacle, whether the obstacle exists or not, and the position of the obstacle in a dead zone outside the sensible zone.

### SUMMARY

It is an aspect of the present invention to provide a robot cleaner that is capable of reflecting an obstacle sensed by obstacle sensors on a local map and a control method and medium of the same.

It is another aspect of the present invention to provide a robot cleaner that is capable of reducing the numbers of operations in using a local map on which an obstacle is reflected to perform obstacle evasion, obstacle lock determination and obstacle lock escape and control method and medium of the same.

In accordance with one aspect of the present invention, there is provided a robot cleaner including an obstacle sensor to sense an obstacle; a memory to store a local map including a plurality of cells; and a control unit to calculate an obstacle position by the obstacle sensor and reflect the calculated obstacle position on the local map.

The local map may be a predetermined zone around the robot cleaner.

The obstacle sensor may be a position sensitive detector.

The control unit may calculate an obstacle distance using an incidence point of an infrared ray sensed by the obstacle sensor and a trigonometrical function, and may calculate the obstacle position using the calculated obstacle distance, an installation position of the obstacle sensor, and an angle between a viewing direction of the obstacle sensor and an advancing direction of the robot cleaner.

The control unit may determine whether cells reflecting the calculated obstacle position are included in cells corresponding to an advance zone of the robot cleaner on the local map, and, when it is determined that the cells reflecting the calculated obstacle position exist, may change the advancing direction of the robot cleaner.

After changing the advancing direction of the robot cleaner, the control unit may determine again whether cells reflecting the calculated obstacle position are included in the cells corresponding to an advance zone of the robot cleaner on the local map, and, when it is determined that the cells reflecting the calculated obstacle position exist, may change the advancing direction of the robot cleaner.

The control unit may control the robot cleaner to selectively or wholly perform wall tracing advance, obstacle lock determination, and obstacle lock escape, using the local map.

In accordance with one aspect of the present invention, there is provided a robot cleaner including an obstacle sensor to sense an obstacle; a memory to store a local map including a plurality of cells; and a control unit to calculate an obstacle zone by the obstacle sensor and reflect the calculated obstacle zone on the local map.

The robot cleaner may be recognized to be less than its actual size on the local map, and the obstacle zone may be a zone enlarged to have a predetermined radius from an obstacle position calculated by the obstacle sensor as the center thereof.

The predetermined radius may be a radius of the robot cleaner.

The size of the robot cleaner recognized on the local map is less than the cell size of the local map.

The control unit may determine whether the obstacle zone is reflected on a cell corresponding to a line extending in an advancing direction of the robot cleaner to evade the obstacle.

In accordance with one aspect of the present invention, there is provided a control method of a robot cleaner including calculating an obstacle distance by an obstacle sensor; calculating an obstacle position based on the obstacle distance and an installation position of the obstacle sensor; and reflecting the obstacle position on a local map including a plurality of cells, the cell on which the obstacle position is reflected being a cell corresponding to the calculated obstacle position.

The control method may further include performing wall tracing control using the cell on which the obstacle position is reflected.

The control method may further include controlling the robot cleaner to evade the obstacle when the cell on which the obstacle position is reflected exists on an advance path of the robot cleaner of the local map.

In accordance with one aspect of the present invention, there is provided a control method of a robot cleaner including calculating an obstacle distance by an obstacle sensor; calculating an obstacle position based the obstacle distance and an installation position of the obstacle sensor; calculating an obstacle zone based on the obstacle position; and reflecting the obstacle zone on a local map including a plurality of cells, the cell on which the obstacle zone is reflected being a cell corresponding to the calculated obstacle zone.

The obstacle zone may be a circle having a predetermined radius from the obstacle position as the center thereof, and the robot cleaner may be recognized to be less than its actual size on the local map.

The control method may include performing wall tracing control using the cell on which the obstacle zone is reflected.

The control method may further include controlling the robot cleaner to evade the obstacle when the cell on which the obstacle zone is reflected exists on a line extending from the center of the robot cleaner in an advancing direction of the robot cleaner.

The control method may further include when determining that the robot cleaner is locked by the obstacle zone on the local map, initializing the local map and controlling the robot cleaner to rotate at a speed lower than an advance speed of the robot cleaner in place to re-create a local map.

The control method may further include controlling the robot cleaner to perform obstacle lock escape using the re-created local map.

In accordance with another aspect of the present invention, there is provided at least one computer readable medium storing computer readable instructions to control at least one processing element to implement methods of embodiments.

### BRIEF DESCRIPTION OF THE DRAWINGS

These and/or other aspects, features, and advantages of the present invention will become apparent and more readily appreciated from the following description of exemplary embodiments, taken in conjunction with the accompanying drawings, of which:

FIG. 1 is a perspective view illustrating a robot cleaner according to a first exemplary embodiment of the present invention;

FIG. 2 is a block diagram illustrating a control system of the robot cleaner according to the first exemplary embodiment of the present invention;

FIG. 3 is a view illustrating the arrangement of obstacle sensors of the robot cleaner according to the first exemplary embodiment of the present invention;

FIG. 4 is a view illustrating a method of reflecting an obstacle position on a local map by the robot cleaner according to the first exemplary embodiment of the present invention;

FIGS. 5 and 6 are flow charts illustrating a control process of the robot cleaner according to the first exemplary embodiment of the present invention;

FIG. 7 is a view illustrating wall tracing advance of the robot cleaner according to the first exemplary embodiment of the present invention;

FIG. 8 is a view illustrating obstacle evasion of the robot cleaner according to the first exemplary embodiment of the present invention;

FIG. 9 is a view illustrating obstacle lock determination and obstacle lock escape of the robot cleaner according to the first exemplary embodiment of the present invention;

FIG. 10 is a view illustrating a method of reflecting an obstacle zone on a local map by a robot cleaner according to a second exemplary embodiment of the present invention;

FIGS. 11 and 12 are flow charts illustrating a control process of the robot cleaner according to the second exemplary embodiment of the present invention;

FIG. 13 is a view illustrating the wall tracing advance of the robot cleaner according to the second exemplary embodiment of the present invention;

FIG. 14 is a view illustrating the obstacle evasion of the robot cleaner according to the second exemplary embodiment of the present invention; and

FIG. 15 is a view illustrating the obstacle lock escape of the robot cleaner according to the second exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to like elements throughout. Exemplary embodiments are described below to explain aspects and features of the present invention by referring to the figures.

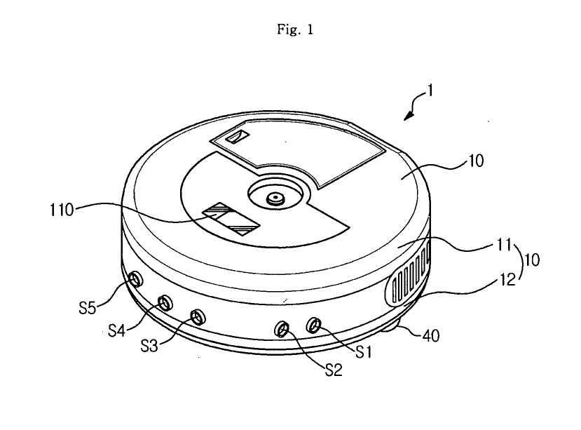

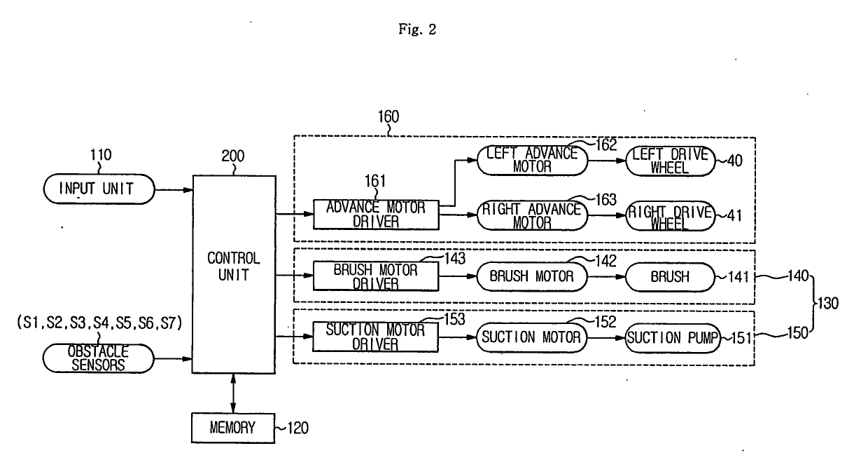

Referring to FIGS. 1 to 4, a robot cleaner 1 according to a first exemplary embodiment of the present invention includes a cleaner body 10 having a battery installed therein, the cleaner body 10 including an upper body 11 and a lower body 12, an input unit 110 formed at one side of the upper body 11 to allow a user to manipulate the robot cleaner 1, a plurality of obstacle sensors S1, S2, S3, S4, S5, S6, and S7 installed at the circumference of the cleaner body 10, a drive unit 160 including left and right advance motors 162 and 163 to rotate left and right drive wheels 40 and 41 rotatably installed in the cleaner body 10 such that the left and right drive wheels 40 and 41 are partially exposed downward from opposite sides of the lower body 12, a cleaning unit 130 including a foreign matter collection unit 140 having a brush motor 142 to rotate a brush 141 partially exposed from the bottom of the cleaner body 10 and a foreign matter suction unit 150 having a suction motor 152 to rotate a suction pump 151 installed in the cleaner body 10, and a control unit 200 to control the overall operation of the robot cleaner 1.

The input unit 110 has a plurality of buttons. The input unit 110 provides a command corresponding to any one of the buttons pushed by a user to the control unit 200.

The drive unit 160 includes left and right drive wheels 40 and 41 rotatably installed at opposite sides of the lower body 12, left and right advance motors 162 and 163 to rotate the left and right drive wheels 40 and 41, respectively, and an advance motor driver 161 to adjust the rotation direction and rotation speed of the left and right advance motors 162 and 163 under the control of the control unit 200. The drive unit 160 drives the robot cleaner 1 to move forward or backward or turn left or right according to an advance command of the control unit 200.

The foreign matter collection unit 140 of the cleaning unit 130 includes a brush 141 to scrape up foreign matter from the floor into the cleaner body 10, a brush motor 142 to rotate the brush 141, and a brush motor driver 143 to drive the brush motor 142. When a drive command from the control unit 200 is inputted to the brush motor driver 143, the brush 141 of the foreign matter collection unit 140 rotates to scrape up foreign matter from the floor into the cleaner body 10.

The foreign matter suction unit 150 of the cleaning unit 130 includes a suction pump 151 to suction the foreign matter scraped up by the foreign matter collection unit 140, a suction motor to rotate the suction pump 151, and a suction motor driver 153 to drive the suction motor 152 under the control of the control unit 200. When a drive command from the control unit 200 is inputted to the suction motor driver 153, the foreign matter suction unit 150 suctions the foreign matter scraped up by the foreign matter collection unit 140 and discharges the suctioned foreign matter into a dust tank (not shown) installed in the cleaner body 10. As a result, the foreign matter accumulates in the dust tank.

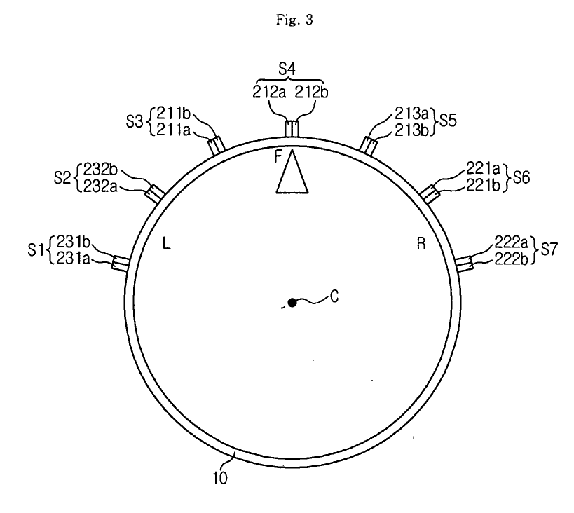

As shown in FIG. 3, the obstacle sensors S1, S2, S3, S4, S5, S6, and S7 include LED light emitters 211a, 212a, 213a, 221a, 222a, 231a, and 232a to emit infrared rays in predetermined directions DS1 to DS7, respectively, and light receivers 211b, 212b, 213b, 221b, 222b, 231b, and 232b to sense incidence points of the infrared rays, emitted from the LED light emitters 211a, 212a, 213a, 221a, 222a, 231a, and 232a and reflected from an obstacle.

When the infrared rays, emitted from the LED light emitters 211a, 212a, 213a, 221a, 222a, 231a, and 232a in the predetermined directions DS1 to DS7, are reflected from the obstacle O and incident on the light receivers 211b, 212b, 213b, 221b, 222b, 231b, and 232b, respectively, the respective obstacle sensors S1, S2, S3, S4, S5, S6, and S7 output incidence points of the incident infrared rays to the control unit 200. The control unit 200, which will be described in the following, calculates obstacle distances D-1 to D-7, i.e., the distances between the obstacle and the respective obstacle sensors S1, S2, S3, S4, S5, S6, and S7 using the incidence points of the infrared rays, inputted from the respective obstacle sensors S1, S2, S3, S4, S5, S6, and S7, and trigonometrical function. Here, a distance calculation method using the incidence points and the trigonometrical function is well known, and therefore, a detailed description thereof will not be given.

The input unit 110, which allows a user to input a command to the control unit 200, and the obstacle sensors S1, S2, S3, S4, S5, S6, and S7, which sense the distance between the robot cleaner 1 and the obstacle, are provided at the input side of the control unit 200. The advance motor driver 161, which drives the left and right advance motors 162 and 163, the brush motor driver 142, which drives the brush motor 142, and the suction motor drives 153, which drives the suction motor 152, are provided at the output side of the control unit 200.

Also, the control unit 200 has a memory 120 to store data and programs required to operate the robot cleaner 1 and a local map LM on which an obstacle position OP around the robot cleaner is reflected.

The local map LM, stored in the memory 120, is constructed in a structure in which the center C of the robot cleaner 1 is a base point of XY coordinates, and a plurality of cells CE are arranged in a matrix pattern to reflect information of the obstacle position OP around the robot cleaner. The length L and the height H of the local map LM are set to be 1M in consideration of the minimum distance between the robot cleaner 1 and the obstacle O required for the robot cleaner 1 to evade the obstacle.

The area of each cell CE is set to be small, such that the resolution of the information of the obstacle position OP on the local map LM can be increased, in consideration of the capacity of the memory 120.

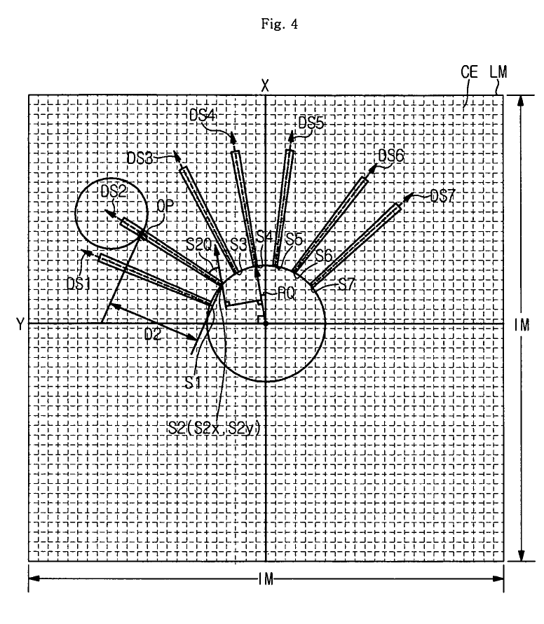

As shown in FIG. 4, the control unit 200 calculates the obstacle distances D-1 to D-7 from the respective obstacle sensors S1, S2, S3, S4, S5, S6, and S7 to the obstacle O using the obstacle sensors S1, S2, S3, S4, S5, S6, and S7. And the control unit 200 sequentially substitutes the installation positions (S1x, S1y) to (S7x, S7y) of the respective obstacle sensors S1, S2, S3, S4, S5, S6, and S7 and the obstacle distances D-1 to D-7 from the respective obstacle sensors S1, S2, S3, S4, S5, S6, and S7 to the obstacle O into the following [Mathematical equation 1] in pairs to calculate the obstacle position OP.

$$O P = [ \begin{matrix}Ox \\ Oy\end{matrix} ] = [ \begin{matrix}Cos ( R θ ) , - Sin ( R θ ) \\ Sin ( R θ ) , Cos ( R θ )\end{matrix} ] * [ \begin{matrix}d * Cos ( S θ ) + Sx \\ d * Sin ( S θ ) + Sy\end{matrix} ] \qquad [ Mathematical Equation 1 ]$$

Where, OP(Ox, Oy) are an obstacle position on the local map LM, (Sx, Sy) are installation positions (S1x, S1y) to (S7x, S7y) of the respective obstacle sensors S1 to S7 on the coordinates of the local map LM when the heading direction HD of the robot cleaner 1 coincides with the X axis of the local map LM, d is obstacle distances D-1 to D-7 between the respective obstacle sensors S1, S2, S3, S4, S5, S6, and S7 and the obstacle O, Sθ represents angles S1θ to S7θ between the viewing directions DS1 to DS7 of the respective obstacle sensors S1, S2, S3, S4, S5, S6, and S7 and the heading direction HD of the robot cleaner 1, and Rθ is an angle between the heading direction HD of the robot cleaner 1 and the X axis of the local map LM.

The control unit 200 searches the cell CE of the local map LM corresponding to the calculated obstacle position OP to reflect the obstacle position OP on the corresponding cell CE.

Also, the control unit 200 controls the robot cleaner 1 to perform obstacle evasion, obstacle lock determination, obstacle lock escape, and wall tracing advance using the local map LM on which the obstacle position OP is reflected.

Hereinafter, a control method of the robot cleaner according to the present invention will be described with reference to the accompanying drawings.

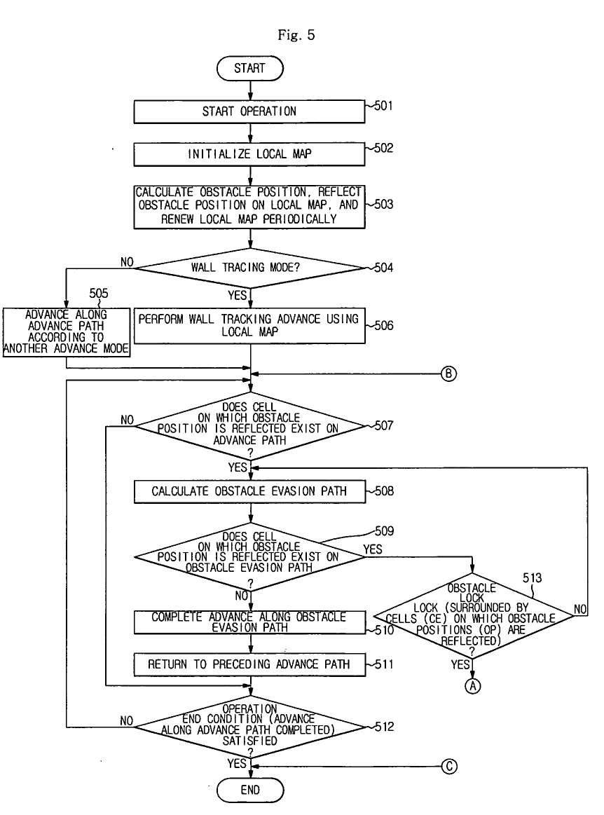

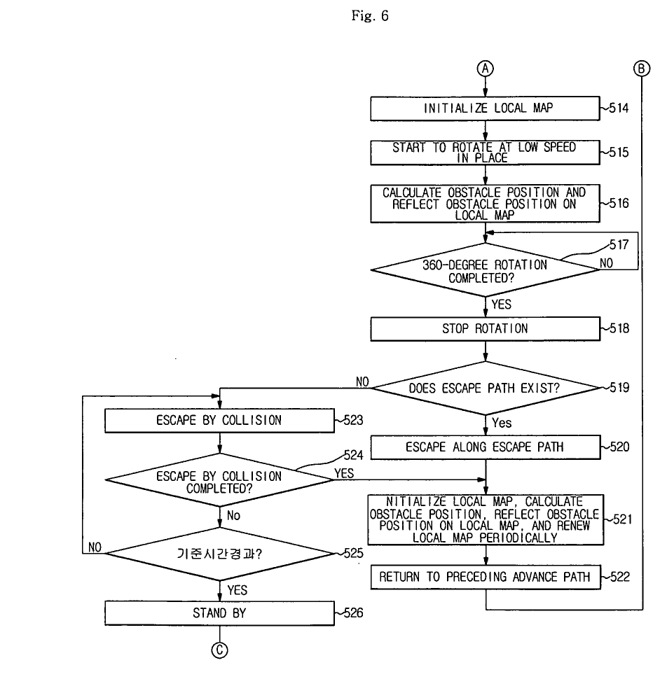

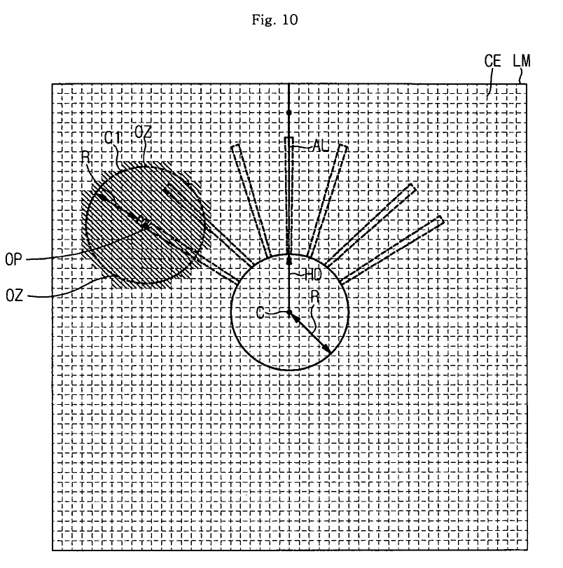

Referring to FIGS. 5 to 10, when a user turns the robot cleaner 1 on and inputs an operation condition, including an advance mode, through the input unit 110, the control unit 200 controls the robot cleaner 1 to start (501).

Subsequently, the control unit 200 initializes the local map LM stored in the memory 120 (502). In other words, the obstacle position OP reflected on the corresponding cell CE of the local map LM is deleted.

Subsequently, the control unit 200 calculates obstacle distances D-1 to D-7, i.e., the distances between the respective obstacle sensors S1, S2, S3, S4, S5, S6, and S7 and the obstacle O using the obstacle sensors S1, S2, S3, S4, S5, S6, and S7, acquires the obstacle position OP using the calculated obstacle distances D-1 to D-7 and the above [Mathematical equation 1], and reflects the acquired obstacle position OP on the corresponding cell CE of the local map LM. And the control unit 200 renews the local map LM periodically (503). Here, the renewal of the local map LM is to move and reflect the obstacle position OP from the cell CE on which the obstacle position OP was reflected to another cell CE of the local map LM corresponding to the translation of the robot cleaner and delete the obstacle position OP from the cell CE on which the obstacle position OP was reflected.

Subsequently, the control unit 200 determines whether the advance mode is a wall tracing (504). When the advance mode is not the wall tracing, the control unit 200 controls the robot cleaner to advance along an advance path corresponding to another different advance mode (505), and controls Step 507 and subsequent steps to be carried out. Here, a random advance and a slant advance may be used as advance modes, in addition to the wall tracing.

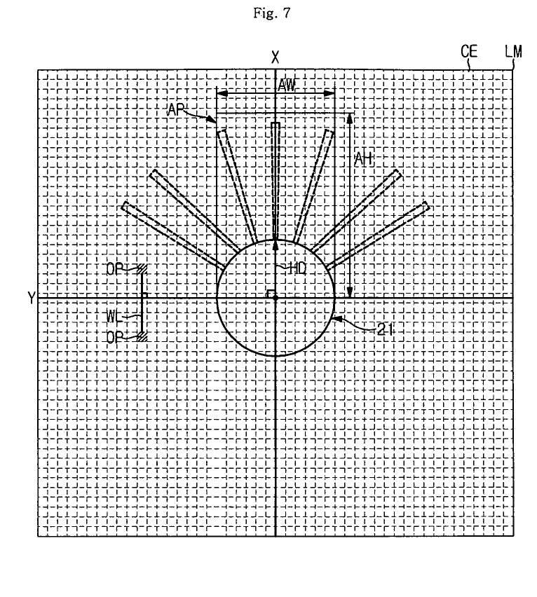

On the other hand, when the advance mode is the wall tracing, the control unit 200 controls the robot cleaner 1 to perform wall tracing advance using the local map LM on which the obstacle position OP is reflected (506). In other words, as shown in FIG. 7, the control unit 200 searches at least two cells CE located on the left of the robot cleaner 1 and at which obstacle positions OP adjacent to the robot cleaner 1 are stored, and interconnects the searched two cells CE to acquire a wall line WL. Subsequently, the control unit 200 calculates the heading direction HD of the robot cleaner 1 in parallel to the wall line WL, and calculates an advance path AP based on the calculated heading direction HD of the robot cleaner 1. Here, the advance path AP means a zone having an advance width AW sufficient for the robot cleaner 1 to pass and a forward length AH variable depending upon the advance speed of the robot cleaner 1. The forward length AH is set in inverse proportion to the advance speed of the robot cleaner 1. After that, the control unit 200 controls the robot cleaner 1 to advance along the calculated advance path AP.

Subsequently, the control unit 200 determines whether any cell CE on which the obstacle position OP is reflected exists on the advance path AP of the local map LM stored in the memory 120, while the control unit 200 controls the robot cleaner 1 to advance along the advance path AP (507).

When any cell CE on which the obstacle position OP is reflected does not exist on the advance path AP, the control unit 200 determines whether an operation end condition is satisfied (512). When the operation end condition is not satisfied, the procedure returns to Step 507, and subsequent steps are carried out. When the operation end condition is satisfied, the control unit 200 controls the robot cleaner to stop. Here, the operation end condition may include the completion of the advance of the robot cleaner 1 along the advance path according to the wall tracing mode or another different advance mode.

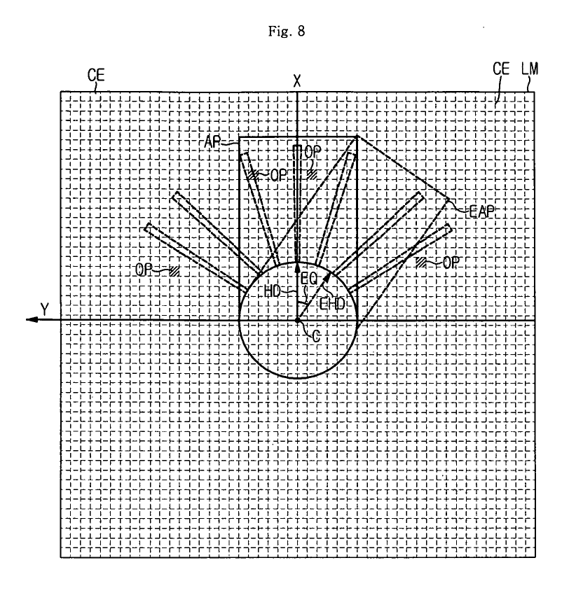

On the other hand, when any cell CE on which the obstacle position OP is reflected exists on the advance path AP, the control unit 200 calculates an obstacle evasion path EAP (508). That is, as shown in FIG. 8, the control unit 200 moves the heading direction HD of the robot cleaner 1 by an obstacle evasion angle EQ to decide an obstacle evasion heading direction EHD and calculates an obstacle evasion path EAP corresponding to the obstacle evasion heading direction EHD.

Subsequently, the control unit 200 determines whether any cell CE on which the obstacle position OP is reflected exists on the obstacle evasion path EAP (509).

When any cell CE on which the obstacle position OP is reflected does not exist on-the obstacle evasion path EAP, the control unit 200 controls the robot cleaner 1 to complete the advance along the obstacle evasion path EAP (510), and return to the advance path according to the wall tracing mode or another different advance mode and advance along the advance path according to the wall tracing mode or another different advance mode (511), and controls Step 512 and subsequent steps to be carried out.

On the other hand, when any cell CE on which the obstacle position OP is reflected exists on the obstacle evasion path EAP, the control unit 200 determines whether the robot cleaner 1 is locked by an obstacle (513). That is, the control unit 200 determines whether the robot cleaner 1 is surrounded by the cells CE on which the obstacle positions OP are reflected. In other words, the control unit 200 determines whether adjacent distances ID between the cells CE on which the obstacle positions OP are reflected are greater than the diameter of the robot cleaner 1.

When the robot cleaner 1 is not locked by the obstacle, the procedure returns to Step 508, and subsequent steps are carried out.

On the other hand, when the robot cleaner 1 is locked by the obstacle, the control unit 200 performs an obstacle lock escape control process.

More specifically, when the robot cleaner 1 is surrounded by the cells CE on which the obstacle positions OP are reflected, the control unit 200 initializes the local map LM, as at Step 502 (514).

Subsequently, the control unit 200 controls the robot cleaner 1 to rotate at low speed in place (515), and calculates the obstacle distances D-1 to D-7, i.e., the distances between the respective obstacle sensors S1, S2, S3, S4, S5, S6, and S7 and the obstacle using the obstacle sensors S1, S2, S3, S4, S5, S6, and S7, acquires the obstacle position OP using the calculated obstacle distances D-1 to D-7 and the above [Mathematical equation 1], reflects the acquired obstacle position OP on the corresponding cell CE of the local map LM, and renews the local map LM periodically, as at Step 503 (516). Subsequently, the control unit 200 determines whether the robot cleaner 1 has completed a 360-degree rotation (517). When the robot cleaner 1 has not completed the 360-degree rotation, the control unit 200 continuously determines whether the robot cleaner 1 has completed the 360-degree rotation. When the robot cleaner 1 has completed the 360-degree rotation, the control unit 200 stops the rotation of the robot cleaner 1 (518).

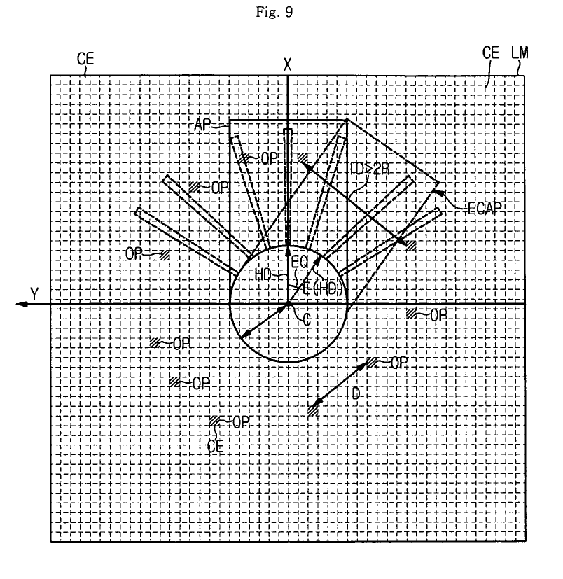

Subsequently, as shown in FIG. 9, the control unit 200 determines whether an obstacle lock escape zone exists on the local map LM (519). In other words, the control unit 200 calculates adjacent distances ID between the cells CE on which the obstacle positions OP are reflected, and determines whether the calculated adjacent distances ID are greater than the diameter 2R of the robot cleaner 1. Here, the obstacle lock escape zone is defined between the cells CE, on which the obstacle positions OP are reflected, having adjacent distances ID greater than the diameter 2R of the robot cleaner 1.

When the obstacle lock escape zone exists on the local map LM, the control unit 200 defines an obstacle lock escape path ECAP toward the obstacle lock escape zone on the local map LM and controls the robot cleaner 1 to advance along the obstacle lock escape path ECAP (520). Subsequently, the control unit 200 initializes the local map, calculates the obstacle distances D-1 to D-7 between the obstacle sensors S1, S2, S3, S4, S5, S6, and S7 and the obstacle using the obstacle sensors S1, S2, S3, S4, S5, S6, and S7, acquires the obstacle position OP using the calculated obstacle distances D-1 to D-7 and the above [Mathematical equation 1], reflects the acquired obstacle position OP on the corresponding cell CE of the local map LM, and renews the local map LM periodically, as in Step 502 and Step 503 (521). Subsequently, the control unit 200 controls the robot cleaner 1 to return to the preceding advance path, and controls Step 507 and subsequent steps to be carried out.

On the other hand, when the obstacle lock escape zone does not exist on the local map LM, the control unit 200 controls the robot cleaner 1 to escape by collision (523). In other words, the control unit 200 calculates adjacent distances ID between the cells CE on which the obstacle positions OP are reflected, searches the longest one of the calculated adjacent distances ID, and defines the obstacle lock escape path ECAP between the cells CE having the longest adjacent distance ID therebetween of the cells CE on which the obstacle positions OP are reflected. Subsequently, the control unit 200 controls the robot cleaner 1 to advance along the obstacle lock escape path ECAP.

Subsequently, the control unit 200 determines whether the robot cleaner 1 has completely escaped by collision (524). Here, whether the robot cleaner 1 has completely escaped by collision may be determined by the determination as to whether the robot cleaner 1 has completed the advance along the obstacle lock escape path ECAP.

When the robot cleaner 1 has completely escaped by collision, the control unit 200 controls Step 520 and subsequent steps to be carried out. On the other hand, when the robot cleaner 1 has not completely escaped by collision, the control unit 200 determines whether time interval from the point of time when the robot cleaner 1 started to escape by collision to the present time has exceeded a predetermined time (525). When the time interval has not exceeded the predetermined time, the procedure returns to Step 523, and subsequent steps are carried out. When the time interval has exceeded the predetermined time, the control unit 200 controls the robot cleaner 1 to be on standby (526).

Hereinafter, a robot cleaner according to a second exemplary embodiment of the present invention will be described with reference to the accompanying drawings. Components of the robot cleaner according to the second exemplary embodiment identical to those of the robot cleaner according to the first exemplary embodiment are denoted by the same reference numerals, and only components of the robot cleaner according to the second exemplary embodiment comparable with those of the robot cleaner according to the first exemplary embodiment will be described.

The control unit 200 of the robot cleaner 1 according to the second exemplary embodiment of the present invention reflects the obstacle zone OZ on the local map LM in a different fashion from the first exemplary embodiment of the present invention. In other words, the control unit 200 of the robot cleaner 1 according to the second exemplary embodiment of the present invention senses the obstacle position OP using the obstacle sensors S1, S2, S3, S4, S5, S6, and S7 and calculates the obstacle zone OZ having the sensed obstacle position as the center thereof. Here, the obstacle zone OZ is a circle having a radius R1 greater than the radius R of the robot cleaner 1 such that the size of the obstacle zone OZ corresponds to the size of the cleaner body 10 of the robot cleaner 1. The control unit 200 searches the cell CE corresponding to the calculated obstacle zone OZ on the local map LM and reflects the obstacle zone OZ on the corresponding cell CE of the local map LM.

Hereinafter, a control method of the robot cleaner according to the second exemplary embodiment of the present invention will be described with reference to the accompanying drawings together with the robot cleaner according to the first exemplary embodiment of the present invention.

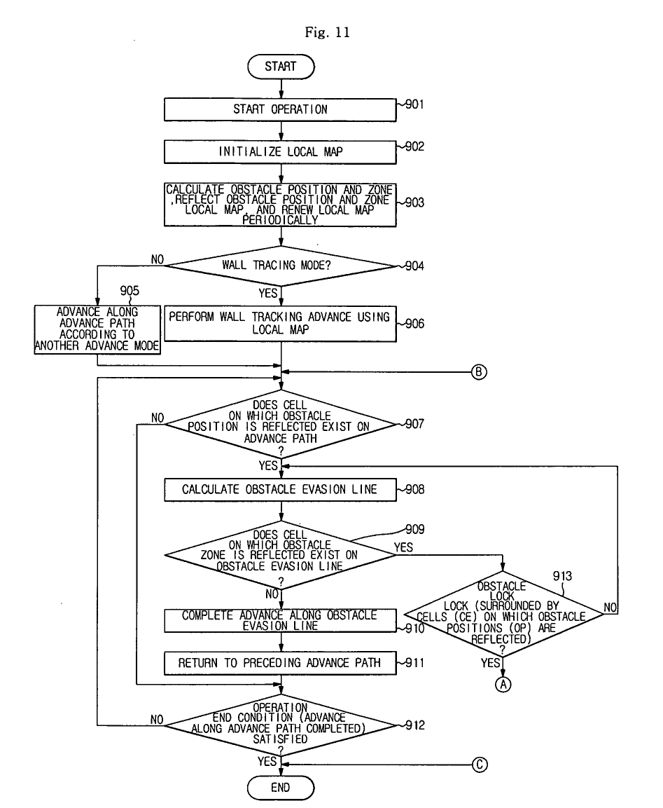

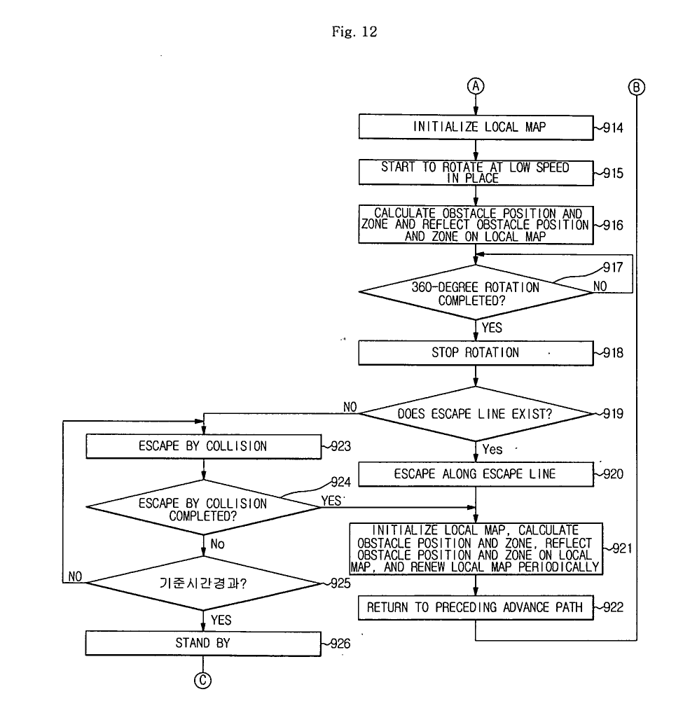

Referring to FIGS. 11 to 15, when a user turns the robot cleaner 1 on and inputs an operation condition, including an advance mode, through the input unit 110, the control unit 200 controls the robot cleaner 1 to start (901).

Subsequently, the control unit 200 initializes the local map LM stored in the memory 120 (902). In other words, the obstacle zone OZ reflected on the corresponding cell CE of the local map LM is deleted.

Subsequently, the control unit 200 calculates obstacle distances D-1 to D-7 between the obstacle sensors S1, S2, S3, S4, 55, S6, and S7 and the obstacle O using the obstacle sensors S1, S2, S3, S4, S5, S6, and S7, acquires the obstacle position OP and the obstacle zone OZ using the calculated obstacle distances D-1 to D-7 and the above [Mathematical equation 1], and reflects the acquired obstacle position OP and the acquired obstacle zone OZ on the corresponding cell CE of the local map LM. And the control unit 200 renews the local map LM periodically (903). Here, the renewal of the local map LM is to move and reflect the obstacle position OP and the obstacle zone OZ from the cell CE on which the obstacle position OP was reflected to another cell CE of the local map LM corresponding to the translation of the robot cleaner and delete the obstacle position OP and the obstacle zone OZ from the cell CE on which the obstacle position OP and the obstacle zone OZ were reflected.

Subsequently, the control unit 200 determines whether the advance mode is a wall tracing (904). When the advance mode is not the wall tracing, the control unit 200 controls the robot cleaner to advance along an advance path corresponding to another different advance mode (905), and controls Step 907 and subsequent steps to be carried out. Here, a random advance and a slant advance may be used as advance modes, in addition to the wall tracing.

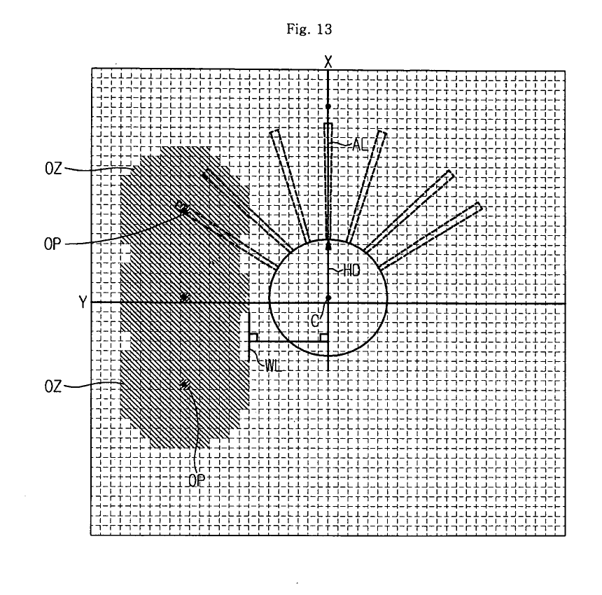

On the other hand, when the advance mode is the wall tracing, the control unit 200 controls the robot cleaner 1 to perform wall tracing advance using the local map LM on which the obstacle position OP and the obstacle zone OZ are reflected (906). In other words, as shown in FIG. 13, the control unit 200 searches at least two cells CE located on the left of the robot cleaner 1 and at which obstacle zones OZ adjacent to the robot cleaner 1 are stored, and interconnects the searched two cells CE to acquire a wall line WL. Subsequently, the control unit 200 calculates the heading direction HD of the robot cleaner 1 in parallel to the wall line WL, and calculates an advance line AL extending from the center of the robot cleaner 1 toward the calculated heading direction HD of the robot cleaner 1. Here, the length of the advance line AL is set in inverse proportion to the advance speed of the robot cleaner 1. After that, the control unit 200 controls the robot cleaner 1 to advance along the calculated advance line AL.

Subsequently, the control unit 200 determines whether any cell CE on which the obstacle zone OZ is reflected exists on the advance line AL of the local map LM stored in the memory 120, while the control unit 200 controls the robot cleaner 1 to advance along the advance line AL (907).

When any cell CE on which the obstacle zone OZ is reflected does not exist on the advance line AL, the control unit 200 determines whether an operation end condition is satisfied (912). When the operation end condition is not satisfied, the procedure returns to Step 907, and subsequent steps are carried out. When the operation end condition is satisfied, the control unit 200 controls the robot cleaner to stop. Here, the operation end condition may include the completion of the advance of the robot cleaner 1 along the advance path according to the wall tracing mode or another different advance mode.

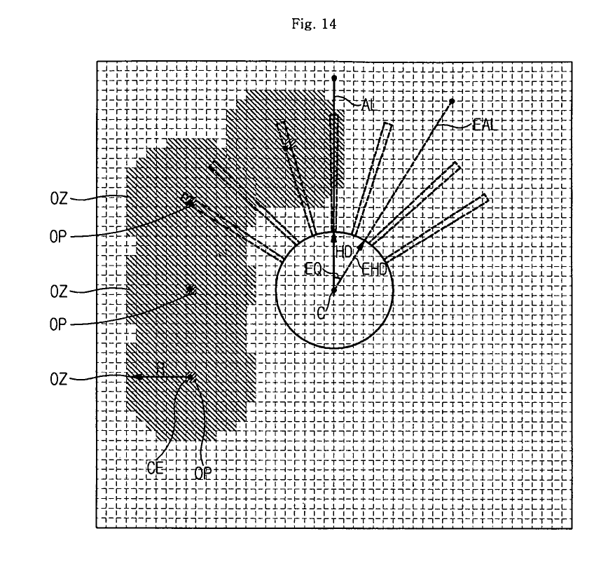

On the other hand, when any cell CE on which the obstacle zone OZ is reflected exists on the advance line AL, the control unit 200 calculates an obstacle evasion line EAL (908). That is, as shown in FIG. 14, the control unit 200 moves the heading direction HD of the robot cleaner 1 by an obstacle evasion angle EQ to decide an obstacle evasion heading direction EHD and calculates an obstacle evasion line EAL extending from the center C of the robot cleaner 1 toward the obstacle evasion heading direction EHD of the robot cleaner 1.

Subsequently, the control unit 200 determines whether any cell CE on which the obstacle zone OZ is reflected exists on the obstacle evasion line EAL (909).

When any cell CE on which the obstacle zone OZ is reflected does not exist on the obstacle evasion line EAL, the control unit 200 controls the robot cleaner 1 to complete the advance along the obstacle evasion line EAL (910), and return to the advance path according to the wall tracing mode or another different advance mode and advance along the advance path according to the wall tracing mode or another different advance mode (911), and controls Step 912 and subsequent steps to be carried out.

On the other hand, when any cell CE on which the obstacle zone OZ is reflected exists on the obstacle evasion line EAL, the control unit 200 determines whether the robot cleaner 1 is locked by an obstacle (913). That is, the control unit 200 determines whether the robot cleaner 1 is surrounded by the cells CE on which the obstacle zones OZ are reflected. In other words, the control unit 200 determines whether adjacent distances ID between the cells CE on which the obstacle zones OZ are reflected are greater than the diameter of the robot cleaner 1.

When the robot cleaner 1 is not locked by the obstacle, the procedure returns to Step 908, and subsequent steps are carried out.

On the other hand, when the robot cleaner 1 is locked by the obstacle, the control unit 200 performs an obstacle lock escape control process.

More specifically, when the robot cleaner 1 is surrounded by the cells CE on which the obstacle positions OP are reflected, the control unit 200 initializes the local map LM, as at Step 902 (914).

Subsequently, the control unit 200 controls the robot cleaner 1 to rotate at low speed in place (915), and calculates the obstacle distances D-1 to D-7 between the respective obstacle sensors S1, S2, S3, S4, S5, S6, and S7 and the obstacle O using the obstacle sensors S1, S2, S3, S4, S5, S6, and S7, acquires the obstacle position OP and the obstacle zone OZ using the calculated obstacle distances D-1 to D-7 and the above [Mathematical equation 1], and reflects the acquired obstacle position OP and the acquired obstacle zone OZ on the corresponding cell CE of the local map LM, as at Step 903. And the control unit 200 renews the local map LM periodically (916). Subsequently, the control unit 200 determines whether the robot cleaner 1 has completed a 360-degree rotation (917). When the robot cleaner 1 has not completed the 360-degree rotation, the control unit 200 continuously determines whether the robot cleaner 1 has completed the 360-degree rotation. When the robot cleaner 1 has completed the 360-degree rotation, the control unit 200 stops the rotation of the robot cleaner 1 (918).

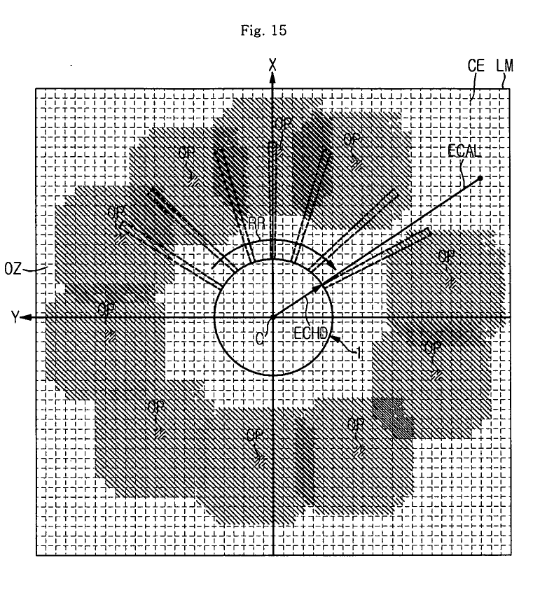

Subsequently, as shown in FIG. 15, the control unit 200 determines whether an obstacle lock escape zone exists on the local map LM (919). In other words, the control unit 200 determines whether the obstacle lock escape line ECAL passes through between the cells CE on which the obstacle zones OZ are reflected,

When the obstacle lock escape zone exists on the local map LM, the control unit 200 defines the obstacle lock escape line ECAL toward the obstacle lock escape zone on the local map LM and controls the robot cleaner 1 to advance along the obstacle lock escape line ECAL (920). Subsequently, the control unit 200 initializes the local map, calculates the obstacle distances D-1 to D-7 between the obstacle sensors S1, S2, S3, S4, S5, S6, and S7 and the obstacle using the obstacle sensors S1, S2, S3, S4, S5, S6, and S7, acquires the obstacle position OP and the obstacle zone OZ using the calculated obstacle distances D-1 to D-7 and the above [Mathematical equation 1], reflects the acquired obstacle position OP and the acquired obstacle zone OZ on the corresponding cell CE of the local map LM, and renews the local map LM periodically, as in Step 902 and Step 903 (921). Subsequently, the control unit 200 controls the robot cleaner 1 to return to the preceding advance path, and controls Step 907 and subsequent steps to be carried out.

On the other hand, when the obstacle lock escape zone does not exist on the local map LM, the control unit 200 controls the robot cleaner 1 to escape by collision (923). In other words, the control unit 200 defines the obstacle lock escape line ECAL toward a zone where the cells CE on which the obstacle zones OZ are reflected are not congested. Subsequently, the control unit 200 controls the robot cleaner 1 to advance along the obstacle lock escape line ECAL.

Subsequently, the control unit 200 determines whether the robot cleaner 1 has completely escaped by collision (924). Here, whether the robot cleaner 1 has completely escaped by collision may be determined by the determination as to whether the robot cleaner 1 has completed the advance along the obstacle lock escape line ECAL.

When the robot cleaner 1 has completely escaped by collision, the control unit 200 controls Step 920 and subsequent steps to be carried out. On the other hand, when the robot cleaner 1 has not completely escaped by collision, the control unit 200 determines whether time interval from the point of time when the robot cleaner 1 started to escape by collision to the present time has exceeded a predetermined time (925). When the time interval has not exceeded the predetermined time, the procedure returns to Step 923, and subsequent steps are carried out. When the time interval has exceeded the predetermined time, the control unit 200 controls the robot cleaner 1 to be on standby (926).

In addition to the above described exemplary embodiments, exemplary embodiments of the present invention can also be implemented through computer readable code/instructions in/on a medium, e.g., a computer readable medium, to control at least one processing element to implement any above described exemplary embodiment. The medium can correspond to any medium/media permitting the storing and/or transmission of the computer readable code/instructions.

The computer readable code/instructions can be recorded/transferred on a medium in a variety of ways, with examples of the medium including computer-readable recording media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), a CD-R (Recordable)/Rewritable, and DVD-R (Recordable/Rewritable). The media may also be a distributed network, so that the computer readable code/instructions is/are stored/transferred and executed in a distributed fashion. Still further, as only an example, the processing element could include a processor or a computer processor, and processing elements may be distributed and/or included in a single device.

For example, exemplary embodiments can be implemented in computing hardware (computing apparatus) and/or software, such as (in a non-limiting example) any computer that can store, retrieve, process and/or output data and/or communicate with other computers. Software includes computer readable code/instructions. The computer readable code/instructions may form a program. The results produced by the implementation of the software can be displayed on a display of the computing hardware. A program/software implementing exemplary embodiments may be recorded on computer-readable media comprising computer-readable recording media discussed above. The program/software implementing exemplary embodiments may also be transmitted over transmission communication media. An example of transmission communication media includes a carrier-wave signal.

Further, according to an aspect of exemplary embodiments, any combination of the described features, functions and/or operations can be implemented.

As apparent from the above description, the robot cleaner and the control method and medium of the same according to exemplary embodiments of the present invention has the effect of reflecting an obstacle sensed by the obstacle sensors on the local map, thereby sensing the position of the obstacle even when the obstacle is located outside the zone sensible by the obstacle sensors.

Also, the robot cleaner and the control method and medium of the same according to exemplary embodiments of the present invention has the effect of reflecting an obstacle sensed by the obstacle sensors on the local map, thereby sensing the position of the obstacle even using a small number of obstacle sensors.

Also, the robot cleaner and the control method and medium of the same according to exemplary embodiments of the present invention has the effect of reflecting an obstacle zone on the local map and determining whether any cell on which an obstacle is reflected exists on an advance line of the robot cleaner to perform obstacle evasion, obstacle lock determination and obstacle lock escape, thereby reducing the numbers of operations required to search the cell.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A robot cleaner comprising:
an obstacle sensor to sense an obstacle;
a memory to store a local map including a plurality of cells; and
a control unit to calculate an obstacle position by the obstacle sensor and reflect the calculated obstacle position on the local map.

2. The robot cleaner according to claim 1, wherein the local map is a predetermined zone around the robot cleaner.

3. The robot cleaner according to claim 1, wherein the obstacle sensor is a position sensitive detector.

4. The robot cleaner according to claim 1, wherein the control unit calculates an obstacle distance using an incidence point of an infrared ray sensed by the obstacle sensor and a trigonometrical function, and calculates the obstacle position using the calculated obstacle distance, an installation position of the obstacle sensor, and an angle between a viewing direction of the obstacle sensor and an advancing direction of the robot cleaner.

5. The robot cleaner according to claim 4, wherein the control unit determines whether cells reflecting the calculated obstacle position are included in cells corresponding to an advance zone of the robot cleaner on the local map, and, when it is determined that the cells reflecting the calculated obstacle position exist, change the advancing direction of the robot cleaner.

6. The robot cleaner according to claim 5, wherein, after changing the advancing direction of the robot cleaner, the control unit determines again whether cells reflecting the calculated obstacle position are included in the cells corresponding to an advance zone of the robot cleaner on the local map, and, when it is determined that the cells reflecting the calculated obstacle position exist, change the advancing direction of the robot cleaner.

7. The robot cleaner according to claim 5, wherein the control unit controls the robot cleaner to selectively or wholly perform wall tracing advance, obstacle lock determination, and obstacle lock escape, using the local map.

8. A robot cleaner comprising:
an obstacle sensor to sense an obstacle;
a memory to store a local map including a plurality of cells; and
a control unit to calculate an obstacle zone by the obstacle sensor and reflect the calculated obstacle zone on the local map.

9. The robot cleaner according to claim 8, wherein
the robot cleaner is recognized to be less than its actual size on the local map, and
the obstacle zone is a zone enlarged to have a predetermined radius from an obstacle position calculated by the obstacle sensor as the center thereof.

10. The robot cleaner according to claim 9, wherein the predetermined radius is a radius of the robot cleaner.

11. The robot cleaner according to claim 10, wherein the size of the robot cleaner recognized on the local map is less than the cell size of the local map.

12. The robot cleaner according to claim 9, wherein the control unit determines whether the obstacle zone is reflected on a cell corresponding to a line extending in an advancing direction of the robot cleaner to evade the obstacle.

13. A control method of a robot cleaner, comprising:
calculating an obstacle distance by an obstacle sensor;
calculating an obstacle position based on the obstacle distance and an installation position of the obstacle sensor; and
reflecting the obstacle position on a local map including a plurality of cells, the cell on which the obstacle position is reflected being a cell corresponding to the calculated obstacle position.

14. The control method according to claim 13, further comprising:
performing wall tracing control using the cell on which the obstacle position is reflected.

15. The control method according to claim 13, further comprising:
controlling the robot cleaner to evade the obstacle when the cell on which the obstacle position is reflected exists on an advance path of the robot cleaner of the local map.

16. A control method of a robot cleaner, comprising:
calculating an obstacle distance by an obstacle sensor;
calculating an obstacle position based the obstacle distance and an installation position of the obstacle sensor;
calculating an obstacle zone based on the obstacle position; and
reflecting the obstacle zone on a local map including a plurality of cells, the cell on which the obstacle zone is reflected being a cell corresponding to the calculated obstacle zone.

17. The control method according to claim 16, wherein
the obstacle zone is a circle having a predetermined radius from the obstacle position as the center thereof, and
the robot cleaner is recognized to be less than its actual size on the local map.

18. The control method according to claim 16, further comprising:
performing wall tracing control using the cell on which the obstacle zone is reflected.

19. The control method according to claim 16, further comprising:
controlling the robot cleaner to evade the obstacle when the cell on which the obstacle zone is reflected exists on a line extending from the center of the robot cleaner in an advancing direction of the robot cleaner.

20. The control method according to claim 18, further comprising:
when determining that the robot cleaner is locked by the obstacle zone on the local map, initializing the local map and controlling the robot cleaner to rotate at a speed lower than an advance speed of the robot cleaner in place to re-create a local map.

21. The control method according to claim 20, further comprising:
controlling the robot cleaner to perform obstacle lock escape using the re-created local map.

22. At least one computer readable medium storing instructions that control at least one processing element to perform the method of claim 13.

23. At least one computer readable medium storing instructions that control at least one processing element to perform the method of claim 16.
